(19) United States
(12) Patent Application Publication
(10) Pub. No.: US 2025/0219862 A1
(43) Pub. Date: Jul. 3, 2025

(54) GATEWAY APPARATUS FOR IMPROVING ROUTING EFFICIENCY BETWEEN HETERGENEOUS NETWORKS AND OPERATION METHOD THEREFOR

(71) Applicant: TELECHIPS INC., Seongnam-si (KR)

(72) Inventors: Sung Hak KANG, Seongnam-si (KR); Ji Eun KIM, Seongnam-si (KR)

(21) Appl. No.: 18/963,280

(22) Filed: Nov. 27, 2024

(30) Foreign Application Priority Data
Jan. 2, 2024 (KR) 10-2024-0000572

(51) Int. Cl. H04L 12/18; H04L 12/46; H04L 12/66

(52) U.S. Cl. CPC H04L 12/1886; H04L 12/46; H04L 12/66

(57) ABSTRACT

Disclosed are a gateway apparatus for improving routing efficiency between heterogeneous vehicle networks and an operation method therefor. The gateway apparatus for improving routing efficiency between heterogeneous networks includes: a communication module that communicates with a non-Ethernet network and an Ethernet network; a memory that stores one or more programs; and a network processor that executes the one or more stored programs, wherein the network processor receives a plurality of non-Ethernet frames from the non-Ethernet network, converts the received non-Ethernet frames into an Ethernet frame, applies first frame conversion information of the converted non-Ethernet frames to the Ethernet frame, and transmits the Ethernet frame with the first frame conversion information applied thereto to the Ethernet network.

### CROSS REFERENCE TO RELATED APPLICATION

This application claims the benefit of priority under 35 U.S.C. §119(a) to Korea Patent Application No. 10-2024-0000572, filed with the Korean Intellectual Property Office on Jan. 2, 2024, which is hereby incorporated by reference in its entirety.

### BACKGROUND

### Field

The present disclosure relates to a technology for improving routing efficiency between heterogeneous vehicle networks, and more particularly, to a gateway technology for improving routing efficiency between heterogeneous networks, in order to maintain characteristics of Ethernet communication and legacy communication for vehicles and at the same time improve routing efficiency through conversion between these two types of communication.

### Description of Related Art

Recently, Ethernet communication devices are becoming increasingly affordable for widespread use on vehicles. These devices are required to receive CAN/LIN (Controller Area Network/Local Interconnect Network) communication information via a gateway apparatus or transmit Ethernet information to a CAN/LIN communication controller.

Since Ethernet communication is still in the early stage of application in vehicles, there are no standards for data conversion between legacy communication and Ethernet communication. Thus, data to be converted via a gateway is generally used by converting frames between Ethernet and legacy communication on a one-to-one basis.

In this instance, using only a single frame as the payload of CAN or LIN data is not efficient because the Ethernet header is lengthy.

A UDP (User Datagram Protocol) frame, which is one of the most commonly used communication protocols, has a header length of 46 bytes; however, when sending an 8-byte classic CAN payload in a single frame, about 15 bytes of data including CAN ID information can fit in the frame, which is shorter than the header.

Moreover, it is not possible to make efficient use of an Ethernet UDP's maximum payload of 1500 bytes. In particular, the more complex the vehicle's system, the larger the amount of data to be converted. Since CAN/LIN communication has the characteristic of periodically transmitting data even when there is no change in data value, sending every converted Ethernet frame to the controller each time legacy data is received may cause overhead on the controller.

An Ethernet frame using Classic CAN data has a longer Ethernet header than CAN data information.

### SUMMARY

Embodiments of the present disclosure provide a gateway apparatus for improving routing efficiency between heterogeneous networks and an operation method therefor, which are used to minimize the size of an Ethernet frame regardless of the number of non-Ethernet frames (e.g., CAN frames, LIN frames, etc.) and to make the most use of the characteristics of each type of communication.

However, the problems to be solved by the present disclosure are not limited thereto, and may be variously extended even in an environment within a range not departing from the spirit and scope of the present disclosure.

An embodiment of the present disclosure provides a gateway apparatus for improving routing efficiency between heterogeneous networks, the gateway apparatus including: a communication module that communicates with a non-Ethernet network and an Ethernet network; a memory that stores one or more programs; and a network processor that executes the one or more stored programs, wherein the network processor receives a plurality of non-Ethernet frames from the non-Ethernet network, converts the received non-Ethernet frames into an Ethernet frame, applies first frame conversion information of the converted non-Ethernet frames to the Ethernet frame, and transmits the Ethernet frame with the first frame conversion information applied thereto to the Ethernet network.

The first frame conversion information may include the number of received non-Ethernet frames.

If the amount of data in the plurality of non-Ethernet frames is equal to or smaller than a preset amount, the Ethernet frame with the first frame conversion information applied thereto may be transmitted to the Ethernet network through broadcast communication.

The network processor may divide a plurality of Ethernet controllers in the Ethernet network into Ethernet controller groups, wherein the Ethernet frame with the first frame conversion information applied thereto may be divided into multicast groups corresponding respectively to the separate Ethernet controller groups and transmitted to the separate Ethernet controller groups through multicast communication.

The network processor may compare the received non-Ethernet frames with a plurality of previously received non-Ethernet frames in a corresponding manner, wherein, according to a comparison result, any non-Ethernet frame with a change may be converted into an Ethernet frame and transmitted to the Ethernet network.

The network processor may receive an Ethernet frame including a plurality of non-Ethernet frames, divide the Ethernet frame into the plurality of non-Ethernet frames by checking second frame conversion information contained in the received Ethernet frame, and route the separate non-Ethernet frames to respective channels of the non-Ethernet network.

The second frame conversion information may include the number of received non-Ethernet frames contained in the received Ethernet frame.

The Ethernet frame including a plurality of non-Ethernet frames may be received on the occurrence of an event, and the separate non-Ethernet frames may be periodically transmitted to the non-Ethernet network.

Another embodiment of the present disclosure provides a gateway operation method performed by a gateway apparatus, the method including: receiving a plurality of non-Ethernet frames from a non-Ethernet network; converting the received non-Ethernet frames into an Ethernet frame; applying first frame conversion information of the converted non-Ethernet frames to the Ethernet frame; and transmitting the Ethernet frame with the first frame conversion information applied thereto to an Ethernet network.

The first frame conversion information may include the number of received non-Ethernet frames.

If the amount of data in the plurality of non-Ethernet frames is equal to or smaller than a preset amount, the Ethernet frame with the first frame conversion information applied thereto is transmitted to the Ethernet network through broadcast communication.

The method may further include dividing a plurality of Ethernet controllers in the Ethernet network into Ethernet controller groups, wherein the Ethernet frame with the first frame conversion information applied thereto may be divided into multicast groups corresponding respectively to the separate Ethernet controller groups and transmitted to the separate Ethernet controller groups through multicast communication.

The method may further include comparing the received non-Ethernet frames with a plurality of previously received non-Ethernet frames in a corresponding manner, wherein, according to a comparison result, any non-Ethernet frame with a change may be converted into an Ethernet frame and transmitted to the Ethernet network.

The method may further include: receiving an Ethernet frame including a plurality of non-Ethernet frames; dividing the Ethernet frame into the plurality of non-Ethernet frames by checking second frame conversion information contained in the received Ethernet frame; and routing the separate non-Ethernet frames to respective channels of the non-Ethernet network.

The second frame conversion information may include the number of received non-Ethernet frames contained in the received Ethernet frame.

The Ethernet frame including a plurality of non-Ethernet frames may be received on the occurrence of an event, and the separate non-Ethernet frames may be periodically transmitted to the non-Ethernet network.

The disclosed technology may have the following effects. However, since it does not mean that a specific embodiment should include all of the following effects or only the following effects, it should not be understood that the scope of the rights of the disclosed technology is limited thereby.

Embodiments of the present disclosure can minimize the size of an Ethernet frame regardless of the number of non-Ethernet frames (e.g., CAN frames, LIN frames, etc.) and make the most use of the characteristics of each type of communication.

A gateway apparatus according to an embodiment of the present disclosure can minimize the size of an Ethernet frame that can be used regardless of the number of conversions of communication data between heterogeneous vehicle networks.

A gateway apparatus according to an embodiment of the present disclosure can optimize the rate of communication load.

A gateway apparatus according to an embodiment of the present disclosure can maintain the characteristics of each type of communication when converting data between Ethernet and non-Ethernet (e.g., CAN, LIN, etc.).

### BRIEF DESCRIPTION OF THE DRAWING

FIG. 1 is a configuration diagram of a vehicle network system including a gateway apparatus for improving routing efficiency between heterogeneous networks according to an embodiment of the present disclosure.

FIG. 2 is a view showing a multicast communication operation by a gateway apparatus according to an embodiment of the present disclosure.

FIG. 3 is a view showing a broadcast communication operation by a gateway apparatus according to an embodiment of the present disclosure.

FIG. 4 is a view showing an Ethernet frame containing first frame conversion information applied by a gateway apparatus according to an embodiment of the present disclosure.

FIG. 5 is a view showing a frame comparison operation by a gateway apparatus according to an embodiment of the present disclosure.

FIG. 6 is a flowchart showing a gateway operation method for improving routing efficiency between heterogeneous networks according to an embodiment of the present disclosure.

FIG. 7 is a view showing an Ethernet frame containing first frame conversion information applied by a gateway apparatus according to an embodiment of the present disclosure, and FIG. 8 is a view showing an Ethernet controller operation for handling an Ethernet frame in an Ethernet network.

FIG. 9 is a view showing an operation of routing an Ethernet frame to a non-Ethernet network by a gateway apparatus according to an embodiment of the present disclosure.

FIG. 10 is a view showing a method of sending an Ethernet frame and a non- Ethernet frame by a gateway apparatus according to an embodiment of the present disclosure.

### DETAILED DESCRIPTION

The present disclosure can make various changes and have various embodiments, and specific embodiments will be illustrated in the drawings and described in detail. However, this is not intended to limit the present disclosure to a specific embodiment, and it should be understood to include all changes, equivalents, or substitutes included in the spirit and scope of the present disclosure. In describing the present disclosure, if it is determined that a detailed description of a related known technology may obscure the gist of the present disclosure, the detailed description thereof will be omitted.

Terms such as first and second may be used for describing various components, but the components should not be limited by the terms. These terms are used only for the purpose of distinguishing one component from another component.

The terms used in the present disclosure are only used to describe specific embodiments, and are not intended to limit the present disclosure. The terms used in the present disclosure may be currently widely used general terms in consideration of the functions in the present disclosure but may vary depending on the intents of those skilled in the art, precedents or the advent of new technology. Additionally, in certain cases, there may be terms that the applicant selects arbitrarily. In this case, their meanings are described in detail in the corresponding description part of the present disclosure. Accordingly, the terms used in the present disclosure should be defined based on the meanings of the terms and the entire contents of the present disclosure rather than simply by the names of the terms.

Singular expressions include plural expressions unless the context clearly indicates otherwise. In the present disclosure, terms such as “comprise”, “include”, or “have” are intended to designate the presence of features, numbers, steps, operations, components, parts, or combinations thereof described in the specification, but it should be understood that they do not preclude in advance the possibility of the presence or addition of one or more other features, numbers, steps, operations, components, parts, or combinations thereof.

Hereinafter, exemplary embodiments will be described in detail with reference to the accompanying drawings, in which like reference numerals refer to like or corresponding elements throughout the figures, and repetitive descriptions thereof will be omitted.

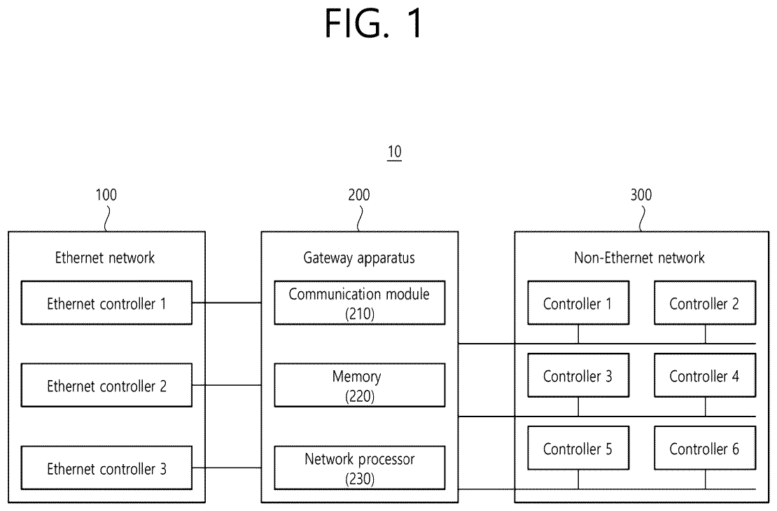

FIG. 1 is a configuration diagram of a vehicle network system including a gateway apparatus for improving routing efficiency between heterogeneous networks according to an embodiment of the present disclosure.

As illustrated in FIG. 1, a vehicle network system 10 including a gateway apparatus 200 according to an embodiment of the present disclosure includes an Ethernet network 100, the gateway apparatus 200, and a non-Ethernet network 300. However, not all of the illustrated components are essential components. The vehicle network system 10 may be implemented by more components than the illustrated ones, or the vehicle network system 10 may be implemented by fewer components.

Hereinafter, detailed configurations and operations of the components of the vehicle network system 10 including the gateway apparatus 200 of FIG. 1 will be described.

The Ethernet network 100 includes a plurality of Ethernet controllers that send and receive Ethernet frames. For example, the plurality of Ethernet controllers may include Ethernet Controllers 1, 2, and 3.

The non-Ethernet network 300 includes a plurality of controllers that send and receive non-Ethernet frames. For example, the plurality of controllers may include Controllers 1 and 2, Controllers 3 and 4, and Controllers 5 and 6.

The gateway apparatus 200 according to an embodiment of the present disclosure efficiently performs routing between the Ethernet network 100 and the non-Ethernet network 300 which are heterogeneous networks.

As illustrated in FIG. 1, the gateway apparatus 200 according to an embodiment of the present disclosure includes a communication module 210, a memory 220, and a network processor 230. However, not all of the illustrated components are essential components. The gateway apparatus 200 may be implemented by more components than the illustrated ones, or the gateway apparatus 200 may be implemented by fewer components.

The communication module 210 communicates with the non-Ethernet network 300 and the Ethernet network 100.

The memory 220 stores one or more programs related to a gateway operation method for improving routing efficiency between heterogeneous networks.

The network processor 230 executes one or more programs stored in the memory 220. Here, the network processor 230 may include a driver capable of sending and receiving an Ethernet frame format and a driver capable of sending and receiving a non-Ethernet frame (e.g., CAN frame, LIN frame, etc.) format. The network processor 230 receives a plurality of non-Ethernet frames from the non-Ethernet network 300, converts the received non-Ethernet frames into an Ethernet frame, applies first frame conversion information of the converted non-Ethernet frames to the Ethernet frame, and transmits the Ethernet frame with the first frame conversion information applied thereto to the Ethernet network 100.

According to embodiments, the first frame conversion information may include a number information of non-Ethernet frame of the plurality of non-Ethernet frames received.

According to embodiments, if the amount of data in the plurality of non-Ethernet frames is equal to or smaller than a preset amount, the Ethernet frame with the first frame conversion information applied thereto may be transmitted to the Ethernet network 100 through broadcast communication.

According to embodiments, the network processor 230 may divide the plurality of Ethernet controllers in the Ethernet network 100 into Ethernet controller groups, and the Ethernet frame with the first frame conversion information applied thereto may be divided into multicast groups corresponding respectively to the separate Ethernet controller groups and transmitted to the separate Ethernet controller groups through multicast communication.

According to embodiments, the network processor 230 may compare the received non-Ethernet frames with a plurality of previously received non-Ethernet frames in a corresponding manner, and, according to a comparison result, any non-Ethernet frame with a change may be converted into an Ethernet frame and transmitted to the Ethernet network 100.

According to embodiments, the network processor 230 may receive an Ethernet frame including a plurality of non-Ethernet frames from the Ethernet network 100, divide it into the plurality of non-Ethernet frames by checking second frame conversion information contained in the received Ethernet frame, and route the separate non-Ethernet frames to respective channels of the non-Ethernet network 300.

According to embodiments, the second frame conversion information may include the number information of the plurality of non-Ethernet frames contained in the plurality of Ethernet frame received.

According to embodiments, the Ethernet frame including a plurality of non-Ethernet frames may be received on the occurrence of an event, and the separate non-Ethernet frames may be periodically transmitted to the non-Ethernet network 300.

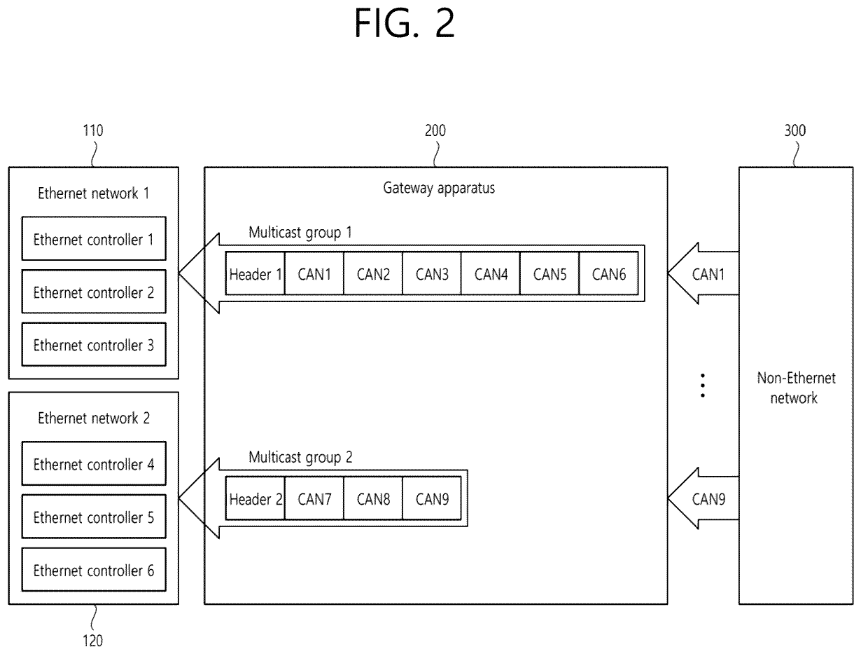

FIG. 2 is a view showing a multicast communication operation by a gateway apparatus according to an embodiment of the present disclosure.

First, the non-Ethernet frames (e.g., CAN frames, LIN frames, etc.) to be converted into an Ethernet frame may differ depending on the vehicle network system. In the case of CAN frames, for example, the gateway apparatus 200 may select and optimize the number of CAN frames to be encapsulated in an Ethernet frame, in order to improve routing efficiency between heterogeneous networks.

In general, large size luxury cars including a vehicle network system by which large quantities of data are sent and received may require a lot of data to be converted between Ethernet network communication and CAN network communication. Accordingly, the gateway apparatus 200 divides Ethernet controllers that frequently share CAN data in the Ethernet network 100 into groups. For example, the gateway apparatus 200 may classify Ethernet Controllers 1 through 3 included in the Ethernet network 100 as Ethernet Network 1 (110) and Ethernet Controllers 4 through 6 as Ethernet Network 2 (120). Also, out of CAN1 to CAN9 frames received from a CAN network, the gateway apparatus 200 may classify the CAN1 through CAN6 frames as Multicast Group 1 including Header 1 and classify the CAN7 through CAN9 frames as Multicast Group 2 including Header 2, and may transmit them to their respective Ethernet control groups through multicast communication.

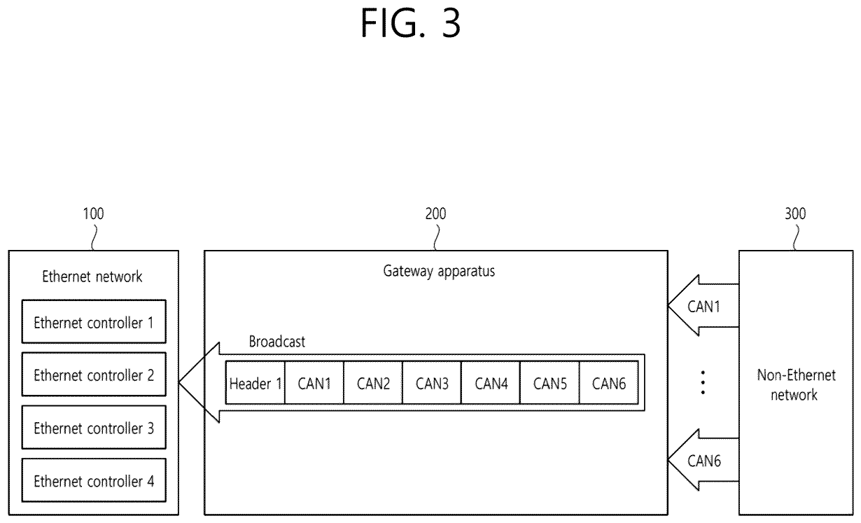

FIG. 3 is a view showing a broadcast communication operation by a gateway apparatus according to an embodiment of the present disclosure.

For small and medium size cars including a vehicle network system by which small and moderate quantities of data are sent and received, the amount of data to be converted into an Ethernet frame is generally smaller than a preset amount. Accordingly, the gateway apparatus 200 transmits the CAN1 to CAN6 frames received from the CAN network by encapsulating them in a single Ethernet frame.

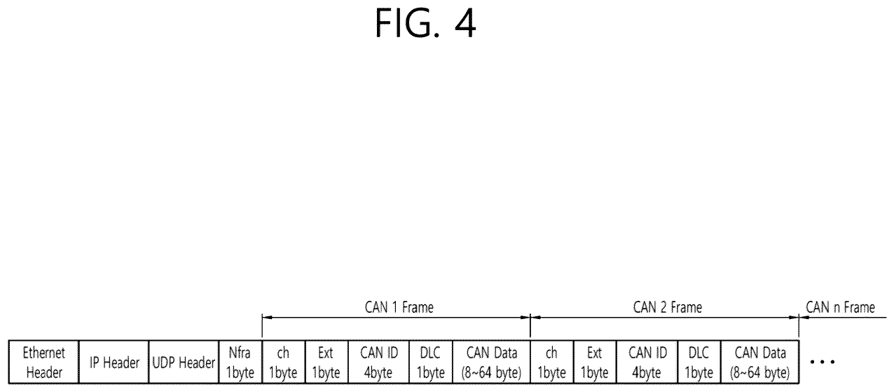

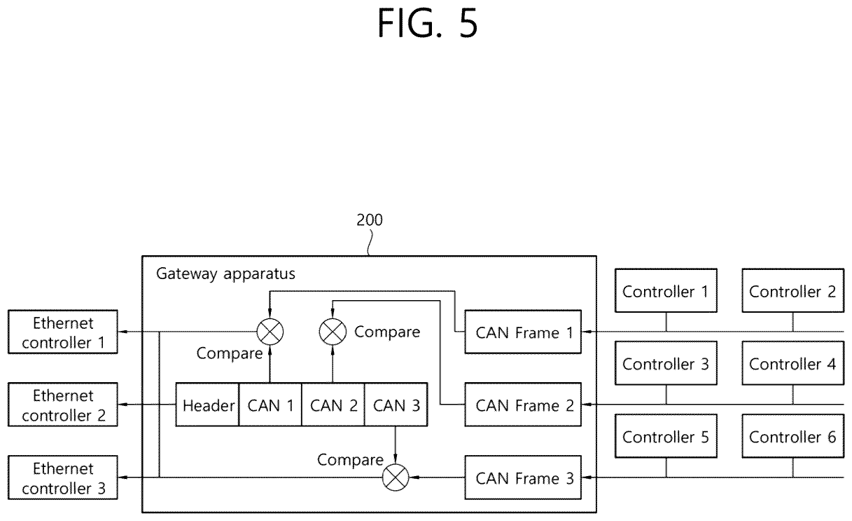

FIG. 4 is a view showing an Ethernet frame containing first frame conversion information applied by a gateway apparatus according to an embodiment of the present disclosure.

The gateway apparatus 200 may assign each message received through a CAN driver to a UDP payload. The gateway apparatus 200 may apply, to the UDP payload, first frame conversion information which is information involving conversion of non-Ethernet frame into Ethernet frame. The gateway apparatus 200 may apply, to the payload, the number of CAN frames and minimum first frame conversion information required for CAN frames to be converted.

As exemplified in FIG. 4, an Ethernet frame with first frame conversion information applied thereto may include an Ethernet header, an IP header, a UDP header, Nfra, ch, Ext, ID, DLC, and CAN Data, wherein Nfra is is the number of CAN frames, ch is CAN channel information, Ext is information indicating whether the ID is an extended ID or a normal ID, ID is a CAN ID, DLC is the length of CAN data, and CAN Data is CAN data.

FIG. 5 is a view showing a frame comparison operation by a gateway apparatus according to an embodiment of the present disclosure.

As illustrated in FIG. 5, the gateway apparatus 200 compares data of each CAN frame with data of a corresponding CAN frame it has previously received, and converts the CAN frame into an Ethernet frame only when there is a change to the data of the CAN frame. Also, the gateway apparatus 200 transmits the Ethernet frame resulting from the conversion through a broadcast message or a multicast message to all Ethernet controllers that require the CAN frame.

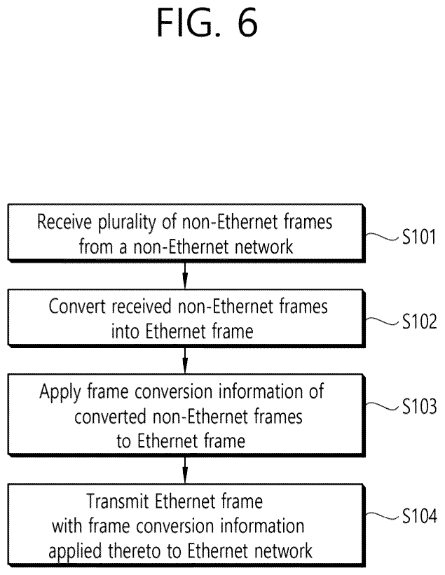

FIG. 6 is a flowchart showing a gateway operation method for improving routing efficiency between heterogeneous networks according to an embodiment of the present disclosure.

In Step S101, the gateway apparatus 200 receives a plurality of non-Ethernet frames from the non-Ethernet network 300.

In Step S102, the gateway apparatus 200 converts the received non-Ethernet frames into an Ethernet frame.

In Step S103, the gateway apparatus 200 applies frame conversion information of the non-Ethernet frames to the Ethernet frame.

In Step S104, the gateway apparatus 200 transmits the Ethernet frame with the frame conversion information applied thereto to the Ethernet network 100.

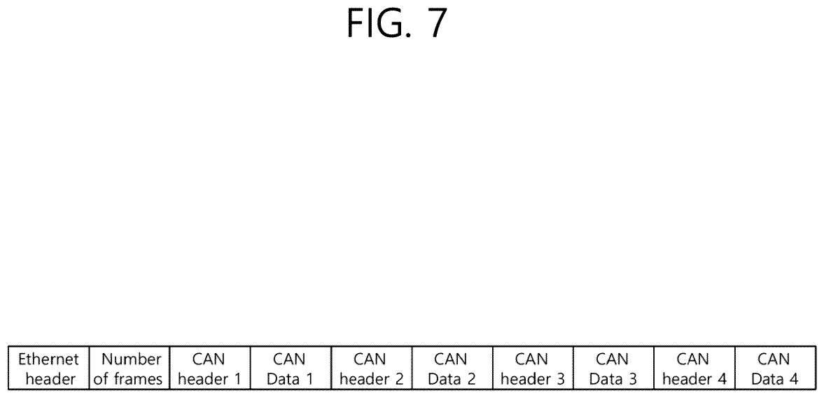

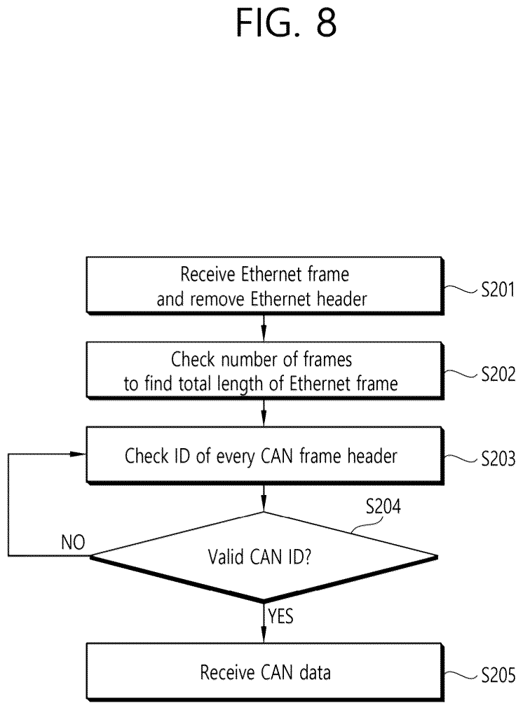

FIG. 7 is a view showing an Ethernet frame containing first frame conversion information applied by a gateway apparatus according to an embodiment of the present disclosure, and FIG. 8 is a view showing an Ethernet controller operation for handling an Ethernet frame in an Ethernet network.

As illustrated in FIG. 7, the Ethernet frame containing first frame conversion information applied by the gateway apparatus 200 may include an Ethernet header, the number of frames, and CAN headers and CAN data corresponding to their respective CAN frames.

Each Ethernet controller in the Ethernet network 100 may only read data of a required CAN frame by checking the number of frames, CAN ID, and DLC information in the Ethernet payload shown in FIG. 7.

Here, as illustrated in FIG. 8, the Ethernet controller operation for handling an Ethernet frame in the Ethernet network 100 will be described below.

In Step S201, the Ethernet controller in the Ethernet network 100 receives an Ethernet frame and removes an Ethernet header from the received Ethernet frame.

In Step S202, the Ethernet controller checks the number of frames to find the total length of the Ethernet frame.

In Step S203, the Ethernet controller checks the ID of every CAN frame header.

In Step S204, the Ethernet controller checks whether the ID is a valid CAN ID.

In Step S205, if the ID is a valid CAN ID, the Ethernet controller receives CAN data corresponding to the valid CAN ID.

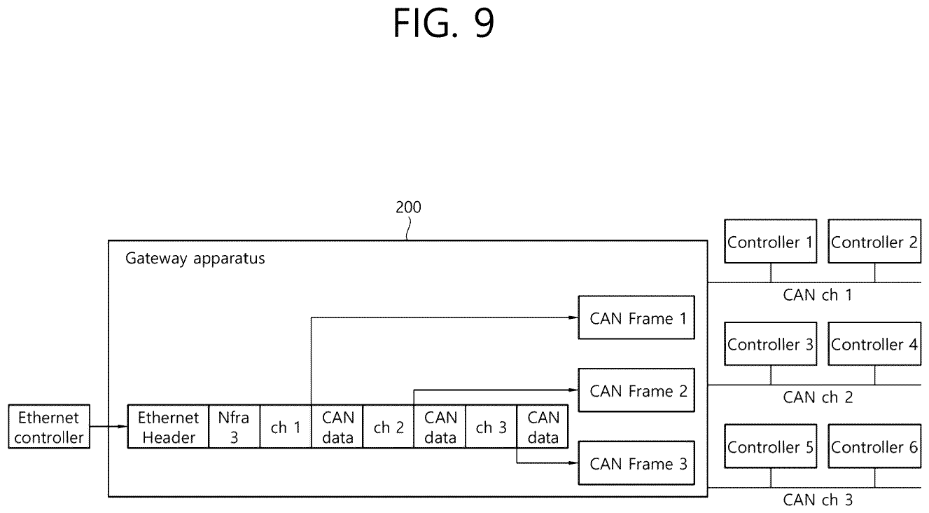

FIG. 9 is a view showing an operation of routing an Ethernet frame to a non-Ethernet network by a gateway apparatus according to an embodiment of the present disclosure.

As illustrated in FIG. 9, each Ethernet controller encapsulates a number of data units to be sent to CAN controllers located in a CAN network in a UDP payload and transmits the data all at once. Here, the UDP payload is in the same format as a frame format transmitted from the CAN network to the Ethernet network.

When routing the Ethernet frame to the CAN network, the gateway apparatus 200 divides the frame by checking the number of frames (Nfra) and CAN DLC information in the payload. Also, the gateway apparatus 200 may route the CAN frames to respective CAN channels.

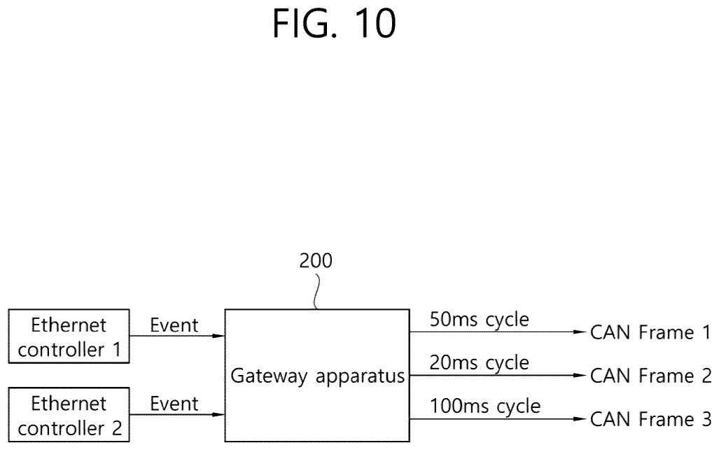

FIG. 10 is a view showing a method of sending an Ethernet frame and a non-Ethernet frame by a gateway apparatus according to an embodiment of the present disclosure.

As illustrated in FIG. 10, the gateway apparatus 200 may receive an Ethernet frame from an Ethernet controller on the occurrence of an event.

On the other hand, the gateway apparatus 200 may periodically send each CAN frame on a preset cycle (e.g., every 50 ms, every 20 ms, every 100 ms, etc.) for a CAN network.

In this way, the gateway apparatus 200 according to an embodiment of the present disclosure can minimize the size of an Ethernet frame that can be used regardless of the number of conversions of communication data between heterogeneous vehicle networks.

The gateway apparatus 200 according to an embodiment of the present disclosure can optimize the rate of communication load by minimizing the size of an Ethernet frame.

The gateway apparatus 200 according to an embodiment of the present disclosure can maintain the characteristics of each type of communication when converting data between Ethernet and non-Ethernet (e.g., CAN, LIN, etc.)

Meanwhile, according to an embodiment of the disclosure, the diverse embodiments described above may be implemented by software including instructions that are stored in machine (e.g., a computer)-readable storage media. The machine is a device that invokes the stored instructions from the storage media and is operable according to the invoked instructions, and may include an electronic device (e.g., electronic device A) according to the disclosed embodiments. When the instructions are executed by the processor, the processor may perform functions corresponding to the instructions, either directly by the processor or using other components under the control of the processor. The instructions may include codes generated or executed by a compiler or an interpreter. The machine-readable storage media may be provided in the form of non-transitory storage media. Here, the term ‘non-transitory’ means that the storage medium does not include a signal and is tangible, but does not distinguish whether data is stored semi-permanently or temporarily in the storage medium.

In addition, according to an embodiment of the disclosure, the method according to the diverse embodiments described above may be included and provided in a computer program product. The computer program product may be traded as a product between a seller and a purchaser. The computer program product may be distributed in the form of a machine readable storage medium (e.g., a compact disc read only memory (CD-ROM)), or distributed online through an application store (e.g., PlayStore™). In the case of the online distribution, at least a portion of the computer program product may be at least temporarily stored in a storage medium such as a memory of a server of a manufacturer, a server of an application store, or a relay server, or be temporarily generated.

In addition, according to an embodiment of the disclosure, the diverse embodiments described above may be implemented in a recording medium readable by a computer or similar device, by using software, hardware, or a combination thereof. In some cases, the embodiments described in the disclosure may be implemented by the processor itself. According to a software implementation, the embodiments such as procedures and functions described in the disclosure may be implemented as separate software modules. Each of the software modules may perform one or more functions and operations described in the disclosure.

Meanwhile, computer instructions for performing processing operations of the device according to the diverse embodiments described above may be stored in a non-transitory computer-readable medium. The computer instructions stored in the non-transitory computer-readable medium allow a specific device to perform the processing operations of the device according to the diverse embodiments described above when being executed by a processor of the specific device. The non-transitory computer-readable medium is not a medium that stores data for a short time such as a register, a cache, a memory, or the like, but means a machine readable medium that semi-permanently stores data. A specific example of the non-transitory computer-readable medium may include a compact disc (CD), a digital versatile disc (DVD), a hard disk, a Blu-ray disc, a universal serial bus (USB), a memory card, a read only memory (ROM), or the like.

In addition, each of the components (e.g., modules or programs) according to the diverse embodiments described above may include a single entity or a plurality of entities, and some sub-components of the sub-components described above may be omitted, or other sub-components may be further included in the diverse embodiments. Alternatively or additionally, some components (e.g., modules or programs) may be integrated into one entity to perform the same or similar functions performed by the respective components prior to the integration. The operations performed by the module, the program, or other component according to the diverse embodiments may be performed in a sequential, parallel, iterative, or heuristic manner, or at least some operations may be executed in a different order or omitted, or other operations may be added.

While exemplary embodiments of the disclosure have been shown and described, the disclosure is not limited to the aforementioned specific embodiments, and various modifications can be made by those having ordinary skill in the art to which the disclosure belongs, without departing from the gist of the disclosure as claimed by the appended claims. Also, it is intended that such modifications are not to be interpreted independently from the technical idea or prospect of the present disclosure.

What is claimed is:

1. A gateway apparatus for improving routing efficiency between heterogeneous networks, the gateway apparatus comprising:
a communication module that communicates with a non-Ethernet network and an Ethernet network;
a memory that stores one or more programs; and
a network processor that executes the one or more stored programs,
wherein the network processor receives a plurality of non-Ethernet frames from the non-Ethernet network, converts the received non-Ethernet frames into an Ethernet frame, applies first frame conversion information of the converted non-Ethernet frames to the Ethernet frame, and transmits the Ethernet frame with the first frame conversion information applied thereto to the Ethernet network.

2. The gateway apparatus of claim 1, wherein the first frame conversion information includes a number information of non-Ethernet frame of the plurality of non-Ethernet frames received.

3. The gateway apparatus of claim 1, wherein, if amount of data in the plurality of non-Ethernet frames is equal to or smaller than a preset amount, the Ethernet frame with the first frame conversion information applied thereto is transmitted to the Ethernet network through broadcast communication.

4. The gateway apparatus of claim 1, wherein the network processor divides a plurality of Ethernet controllers in the Ethernet network into Ethernet controller groups,
wherein the Ethernet frame with the first frame conversion information applied thereto is divided into multicast groups corresponding respectively to separate Ethernet controller groups and transmitted to the separate Ethernet controller groups through multicast communication.

5. The gateway apparatus of claim 1, wherein the network processor compares the received non-Ethernet frames with a plurality of previously received non-Ethernet frames in a corresponding manner,
wherein, according to a comparison result, any non-Ethernet frame with a change is converted into the Ethernet frame and transmitted to the Ethernet network.

6. The gateway apparatus of claim 1, wherein the network processor receives the Ethernet frame including the plurality of non-Ethernet frames, divides the Ethernet frame into the plurality of non-Ethernet frames by checking second frame conversion information contained in the received Ethernet frame, and routes separate non-Ethernet frames to respective channels of the non-Ethernet network.

7. The gateway apparatus of claim 6, wherein the second frame conversion information includes a number information of the plurality of non-Ethernet frames contained in the Ethernet frame received.

8. The gateway apparatus of claim 6, wherein the Ethernet frame including the plurality of non-Ethernet frames is received on an occurrence of an event, and the separate non-Ethernet frames are periodically transmitted to the non-Ethernet network.

9. A gateway operation method performed by a gateway apparatus, the method comprising:
receiving a plurality of non-Ethernet frames from a non-Ethernet network;
converting the received non-Ethernet frames into an Ethernet frame;
applying first frame conversion information of the converted non-Ethernet frames to the Ethernet frame; and
transmitting the Ethernet frame with the first frame conversion information applied thereto to an Ethernet network.

10. The method of claim 9, wherein the first frame conversion information includes a number information of non-Ethernet frame of the plurality of non-Ethernet frames received.

11. The method of claim 9, wherein, if amount of data in the plurality of non-Ethernet frames is equal to or smaller than a preset amount, the Ethernet frame with the first frame conversion information applied thereto is transmitted to the Ethernet network through broadcast communication.

12. The method of claim 9, further comprising dividing a plurality of Ethernet controllers in the Ethernet network into Ethernet controller groups,
wherein the Ethernet frame with the first frame conversion information applied thereto is divided into multicast groups corresponding respectively to separate Ethernet controller groups and transmitted to the separate Ethernet controller groups through multicast communication.

13. The method of claim 9, further comprising comparing the received non-Ethernet frames with a plurality of previously received non-Ethernet frames in a corresponding manner,
wherein, according to a comparison result, any non-Ethernet frame with a change is converted into the Ethernet frame and transmitted to the Ethernet network.

14. The method of claim 9, further comprising:
receiving the Ethernet frame including the plurality of non-Ethernet frames;
dividing the Ethernet frame into the plurality of non-Ethernet frames by checking second frame conversion information contained in the received Ethernet frame; and
routing separate non-Ethernet frames to respective channels of the non-Ethernet network.

15. The method of claim 14, wherein the second frame conversion information includes a number information of the plurality of non-Ethernet frames contained in the Ethernet frame received.

16. The method of claim 14, wherein the Ethernet frame including the plurality of non-Ethernet frames is received on an occurrence of an event, and the separate non-Ethernet frames are periodically transmitted to the non-Ethernet network.
